(19) United States
(12) Patent Application Publication
(10) Pub. No.: US 2018/0164533 A1
(43) Pub. Date: Jun. 14, 2018

(54) Lens and Lens Module

(71) Applicant: Haiyang Qiu, Shenzhen (CN)

(72) Inventor: Haiyang Qiu, Shenzhen (CN)

(73) Assignee: AAC Technologies Pte. Ltd., Singapore city (SG)

(21) Appl. No.: 15/417,216

(22) Filed: Jan. 26, 2017

(30) Foreign Application Priority Data
Dec. 10, 2016 (CN) 201621353140.8

(51) Int. Cl. G02B 7/02; G02B 13/18

(52) U.S. Cl. CPC G02B 7/022; G02B 13/18

(57) ABSTRACT

The present disclosure provides a lens, including a body portion which serves as an imaging region, a peripheral portion which extends outward from the body portion and a groove. The peripheral portion includes a top surface, a bottom surface arranged opposite to the top surface and a side wall which connects the top surface with the bottom surface, the groove is arranged at the side wall, the groove is formed in a manner that an external surface of the side wall sinks toward an optical axis of the lens, and the groove is filled with a black material. The present disclosure further provides a lens module. Compared with relevant art, the lens and lens modules of the present disclosure have good optical performance and high assembling efficiency.

### TECHNICAL FIELD

The present disclosure relates to the field of optical imaging and, particularly, relates to a lens and a lens module applied to the field of products for photographing and shooting.

### BACKGROUND

With the development of technologies, the electronics have been developed more and more smart, in addition to digital cameras, portable electronic devices such as tablet PC and cellphones have all been provided with a lens module for photographing and shooting, so as to satisfy the demands of users for photographing at any time.

In the related art, the lens module includes a lens barrel, lenses arranged inside the lens barrel, light shading sheets or light shading plates each being clamped between two adjacent lenses and a pressing ring provided between the lens at the bottom and the lens barrel, and the pressing ring is fixed with the lens barrel by glue dispensing, so as to realize fixation of the lenses. The lens inside the lens module includes a body portion which serves as an imaging region and a peripheral portion which extends from the body portion.

However, a side surface of the peripheral portion is of an integral structure with a column shape, light is reflected from the side surface of the peripheral portion and generates stray light, which affects the optical performance of the lens.

Thus, it is necessary to provide a new lens and lens module to solve the above-mentioned problem.

### BRIEF DESCRIPTION OF DRAWINGS

Many aspects of the exemplary embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a perspective structural view of a lens in accordance with the present disclosure (a groove is not filled with a black material);

FIG. 2 is a structural schematic diagram of a lens in accordance with the present disclosure;

FIG. 3 is a sectional view along line A-A in FIG. 1 (a black material has been filled);

FIG. 4 is a structural schematic diagram of a lens module in accordance with the present disclosure.

### DESCRIPTION OF EMBODIMENTS

The present application will be further illustrated with reference to the accompanying drawings and the embodiments.

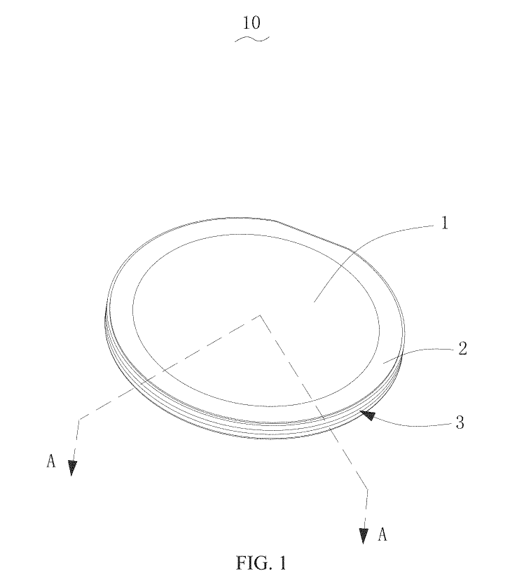

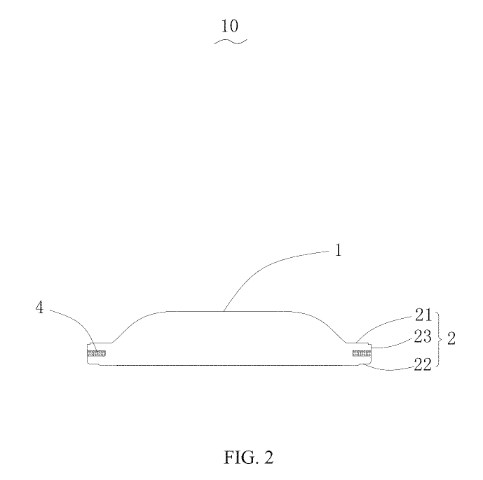

With reference to FIGS. 1-3, FIG. 1 is a perspective structural view of a lens in accordance with the present disclosure (a groove is not filled with a black material);

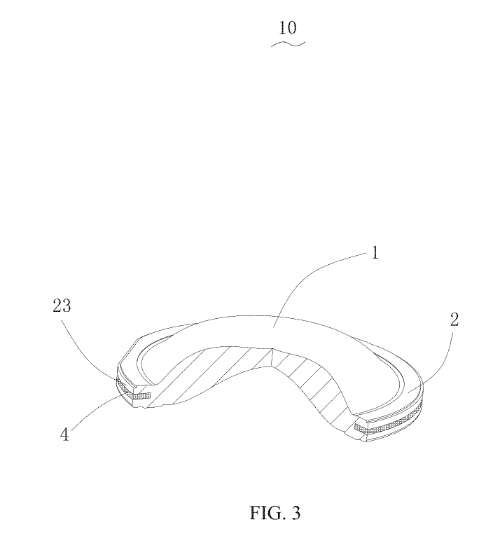

FIG. 1 is a perspective structural view of a lens in accordance with the present disclosure; FIG. 3 is a sectional view along line A-A in FIG. 1 (a black material has been filled).

The present disclosure provided a lens 10, including a body portion 1 which serves as an imaging region, a peripheral portion 2 which extends outward from the body portion 1, a groove 3 and a black material 4.

A surface of the body portion 1 is a curved surface, such as spherical surface or aspherical surface.

The peripheral portion 2 includes a top surface 21, a bottom surface 22 arranged opposite to the top surface 21 and a side wall 23 which connects the top surface 21 with the bottom surface 22. It should be noted that, the top surface 21 and the bottom surface 22 can be interpreted as an object side surface and an image side surface of the lens 10, respectively.

The groove 3 is provided at the side wall 23, and the groove 3 is formed in a manner that an external surface of the side wall 23 sinks toward an optical axis of the lens 10, which has the function of adjusting the mold flow and improving the molding effect of the lens 10.

Specifically, in the present embodiment, the groove 3 is configured perpendicular to an optical axis of the lens 10, i.e., a plane where the groove 3 is located is perpendicular to the optical axis of the lens 10. The groove 3 is of a ring-shaped structure, or a structure to be a part of a ring within a same principle, and the ring-shaped structure has better light blocking effect.

The black material 4 is filled in the groove 3. In the present embodiment, the black material 4 is a black paint or a black coating material. Of course, there is no limitation on the material of the black material 4, as long as it can absorb and block light. The black material 4 can substitute a light shading sheet for shading light, reduce a total track length (Total Track Length, TTL), and at the same time reduces the number of components of the lens 10 when applied to other products, so as to save assembling time.

Besides, a cross-section of the groove 3 along a direction parallel to the optical axis is a rectangular or trapezoid, however, there is no limitation herein. The configuration of this structure can absorb light and prevent reflection which may generate stray light, and at the same time reduces the usage amount of the black material 4, i.e., saves manufacturing cost.

In the present embodiment, the body portion 1, the peripheral portion 2 and the groove 3 are formed by integral injection molding.

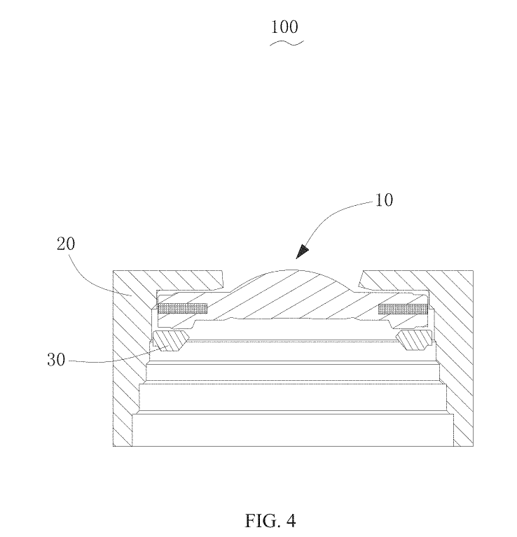

FIG. 4 is a structural schematic diagram of a lens module in accordance with the present disclosure. The present disclosure further provides a lens module 100, including a lens barrel 20, the above-mentioned lens 10 accommodated in the lens barrel 20 and a pressing ring 30, the lens 10 is fixedly connected with the lens barrel 20 via the peripheral portion 2, the pressing ring 30 fixes the lens 10 in the interior of the lens barrel 20 by glue dispensing.

When at least one lens 10 of the present disclosure is assembled into the lens module 100, the side wall 23 of the peripheral portion 2 can have the effect of shading the stray light without the need of an additional light blocking structure, which is convenient in use and reduces assembly components used when being assembled into a relevant product, and thus improves assembling efficiency.

Comparing with prior art, the lens of the present disclosure is provided with a groove at the side wall of the peripheral portion thereof, which has the function of adjusting the mold flow and improving the molding effect of the lenses; the groove is filled with a black material, such that the side wall of the lens can block the light and reduce stray light, so as to improve imaging quality; when the lens is assembled into the lens module provided by the present disclosure, there is no need for additional light blocking structures, and thus the number of components of the lens module is reduced, which simplifies the assembling process, improves the assembling efficiency and achieves good optical performance.

The above are merely embodiments of the present application, which are not used to limit the protection scope of the present application, all the equivalent structures or variations obtained based on the description and drawings of the present disclosure, or direct or indirect application in other relevant technical fields, shall fall into the protection scope of the present application.

1. a lens, comprising:
a body portion which serves as an imaging region;
a peripheral portion which extends outward from the body portion, the peripheral portion comprises a top surface, a bottom surface arranged opposite to the top surface and a side wall which connects the top surface with the bottom surface; and
a groove provided at the side wall, the groove is formed in a manner that an external surface of the side wall sinks toward an optical axis of the lens, and the groove is filled with a black material.

2. The lens as described in claim 1, wherein the black material is a black paint.

3. The lens as described in claim 1, wherein the black material is a black coating material.

4. The lens as described in claim 3, wherein the groove is of a ring-shaped structure.

5. The lens as described in claim 4, wherein a cross-section of the groove along a direction parallel to the optical axis is a rectangular or trapezoid.

6. The lens according to claim 5, wherein a surface of the body portion is of a structure with a curved surface.

7. A lens module, comprising a lens barrel and at least one lens according to claim 1 accommodated in the lens barrel.

8. The lens according to claim 1, wherein the side wall is annular.

9. The lens according to claim 1, wherein the black material fills the entire groove so that the side wall of the lens is a complete curved surface without the groove.

10. The lens module according to claim 7, wherein at least a portion of the black material abuts the lens barrel.
